(19) United States
(12) Patent Application Publication
(10) Pub. No.: US 2021/0278973 A1
(43) Pub. Date: Sep. 9, 2021

(54) METHOD OF PLACING VOLUME ON CLOSER STORAGE FROM CONTAINER

(71) Applicant: Hitachi, Ltd., Tokyo (JP)

(72) Inventors: Akiyoshi TSUCHIYA, San Jose, CA (US); Masanori TAKADA, Santa Clara, CA (US); Hiroyuki OSAKI, Los Gatos, CA (US)

(73) Assignee: Hitachi, Ltd.

(21) Appl. No.: 16/812,050

(22) Filed: Mar. 6, 2020

(51) Int. Cl. G06F 3/06; G06F 9/48

(52) U.S. Cl. CPC G06F 3/0611; G06F 3/0644; G06F 3/0647; G06F 9/4881; G06F 3/067; G06F 3/0683; G06F 3/0653

(57) ABSTRACT

Embodiments described herein are directed to volume creation such that the volume is created in the storage system that is closest to the group of servers that the container is likely to be launched. Through such embodiments, the volume can be created or migrated in anticipation to a launch or a relaunch of a container.

### BACKGROUND

### Field

The present disclosure is generally related to storage systems, and more specifically, to systems and methods for placing a volume in a storage system that is closer to the application container (hereafter referred to as “container”).

### Related Art

Container implementations have become utilized to facilitate an agile and flexible application execution platform. Container is a type of virtualization technology. Previously, containers have been used for stateless applications which do not store data in the data storage system. In the related art, the use of container has expanded to stateful applications which store data to data storage systems. To deploy and manage the containerized application on the server cluster, container orchestration systems such as Kubernetes are used.

The location of the container among the servers in the server cluster is dynamically decided by the orchestration system when the container is launched.

In related art implementations, there are systems that automatically switch the access path from the previous container location to the new container location. This mechanism keeps data accessible from containers even if containers are moved between servers.

In a related art implementation, there is a data migration mechanism between servers. When a virtual machine (VM) using a data volume is moved between servers in the server cluster, this mechanism moves the volume to a storage system that is closer to the destination server of a VM. Such mechanisms prevent performance degradation of data access due to worse communication latency between a server and a storage.

### SUMMARY

Related art implementations may cause performance degradation if the container is located in a server that is far from a storage system managing a data volume used by the container. Further, the mechanisms of the related art may cause an unnecessary migration of data volumes. Although the VM can run for a long time, the variance of the running time of the container can be large. Some containers run in a short time. If the running time is short, data migration is unnecessary because the container terminate soon and may be located to another server at next execution.

Aspects of the present disclosure can involve a method for storage management in conjunction with computing unit management in a system having a plurality of servers and a plurality of storage systems, the method involving, for a request of creating a new volume or attaching an existing volume for a computing unit to be launched: determining, from configuration information, one or more servers from the plurality of servers to which the computing unit is to be launched; estimating performance for each storage system among at least a subset of the plurality of storage systems connected to the determined one or more servers; selecting a storage system from the at least the subset of the plurality of storage systems connected to the determined one or more servers based on the estimated performance; and creating a new volume or migrating an existing volume to the selected storage system.

Aspects of the present disclosure can involve a non-transitory computer readable medium, storing instructions for storage management in conjunction with computing unit management in a system having a plurality of servers and a plurality of storage systems, the instructions involving, for a request of creating a new volume or attaching an existing volume for a computing unit to be launched: determining, from configuration information, one or more servers from the plurality of servers to which the computing unit is to be launched; estimating performance for each storage system among at least a subset of the plurality of storage systems connected to the determined one or more servers; selecting a storage system from the at least the subset of the plurality of storage systems connected to the determined one or more servers based on the estimated performance; and creating a new volume or migrating an existing volume to the selected storage system.

Aspects of the present disclosure can involve a system having a plurality of servers and a plurality of storage systems, the system involving, for a request of creating a new volume or attaching an existing volume for a computing unit to be launched: means for determining, from configuration information, one or more servers from the plurality of servers to which the computing unit is to be launched; means for estimating performance for each storage system among at least a subset of the plurality of storage systems connected to the determined one or more servers; means for selecting a storage system from the at least the subset of the plurality of storage systems connected to the determined one or more servers based on the estimated performance; and means for creating a new volume or migrating an existing volume to the selected storage system.

Aspects of the present disclosure can involve a system involving a plurality of servers and a plurality of storage systems, the system involving, for a request for volume creation for a container to be launched, means for determining, from configuration information, one or more servers from the plurality of server to which the container is likely to be launched; means for selecting a storage system from the plurality of storage systems that is closest to the one or more servers to which the container is likely to be launched; means for creating a volume on the selected storage system; and means for launching the container.

Aspects of the present disclosure can involve an apparatus for a system involving a plurality of servers and a plurality of storage systems, the apparatus involving a processor, configured to, for a request for volume creation for a container to be launched, determine, from configuration information, one or more servers from the plurality of server to which the container is likely to be launched; select a storage system from the plurality of storage systems that is closest to the one or more servers to which the container is likely to be launched; create a volume on the selected storage system; and launch the container.

### BRIEF DESCRIPTION OF DRAWINGS

FIG. 1 illustrates an example of a system and an overall processing in accordance with a first embodiment.

FIG. 2 illustrates an example affinity setting of the container, in accordance with some embodiment.

FIG. 3 illustrates an example of the server configuration information, in accordance with some embodiment.

FIG. 4 illustrates an example of the storage configuration information, in accordance with some embodiment.

FIG. 5 illustrates an example of the volume creation function in accordance with a first embodiment.

FIG. 6 illustrates an example of a system and an overall processing flow, in accordance with a second embodiment.

FIG. 7 illustrates an example determination of the necessity of volume migration, in accordance with a second embodiment.

FIG. 8 illustrates an example of volume information, in accordance with a second embodiment.

FIG. 9 illustrates an example of container location information, in accordance with a second embodiment.

FIG. 10 illustrates an example flow diagram for the determination of the necessity of volume migration, in accordance with a second embodiment.

FIG. 11 illustrates an example computing environment with an example computer device suitable for use in some embodiment.

### DETAILED DESCRIPTION

The following detailed description provides details of the figures and embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Embodiments as described herein can be utilized either singularly or in combination and the functionality of the embodiments can be implemented through any means according to the desired implementations.

Further, in the following description, the information is expressed in a table format, but the information may be expressed in any data structure. Further, in the following description, a configuration of each information is an example, and one table may be divided into two or more table or a part or all of two or more tables may be one table.

In a first embodiment, there is a volume creation method that creates the volume in the storage system closest to the servers on which the container is likely to be launched.

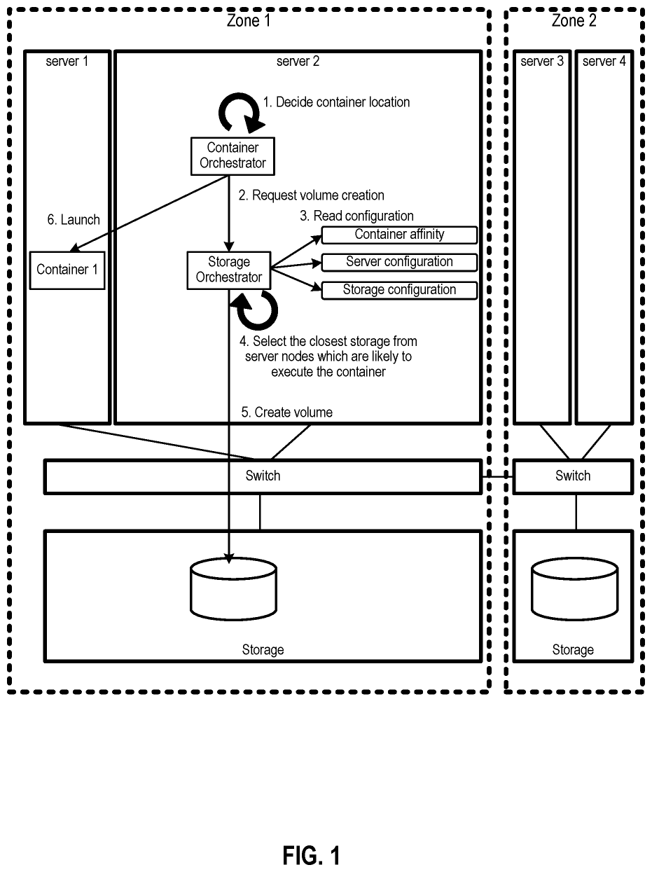

FIG. 1 illustrates an example of a system and an overall processing upon which embodiments can be applied. The system can include multiple servers and storage systems that are connected via network. The network configuration in FIG. 1 is an example. Network can be configured with such as spine-leaf or fat tree architecture. To orchestrate the execution of the container, the container orchestrator is running on the server. When the container is launched, the container orchestrator reads the affinity setting of the container and the server configuration information. Based on such information, the container orchestrator determines the location of the container.

Then, the container orchestrator requests the storage orchestrator to create a volume. Upon receiving the request, the storage orchestrator selects a storage system that is closest to the group of servers that are likely to be selected for the container placement. This decision is done based on the affinity setting of the container, the server configuration information and the storage configuration information. After selecting the storage, the storage orchestrator requests the storage system to create the volume. Upon receiving the request, the storage system creates the volume. After creation of the volume, the container orchestrator launches the container with attaching the created volume.

According to this embodiment, the volumes are created in the storage systems that is the closest to the group of servers likely to be selected for container placement. This means that volumes are created in the storage systems which has the highest probability that the storages are closest from containers. Therefore, even if container is launched on another server at next launch, distance between a container and a volume can be expected to keep close.

The container orchestrator and storage orchestrator may be executed on a specific server of a plurality of servers. They may also be executed on multiple server of a plurality of servers.

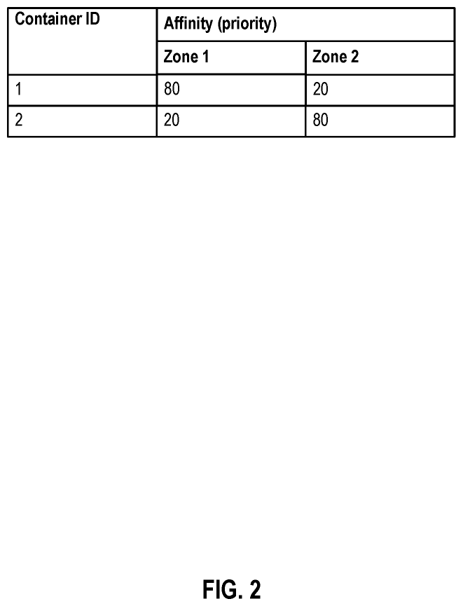

FIG. 2 illustrates an example affinity setting of the container, in accordance with some embodiment. Servers are usually managed based on their corresponding zone unit. The zone usually configured based on facility configuration unit (e.g., rack, floor of data center, etc.). In order to place containers with strong dependencies close to each other, priority is assigned to the zone in which the containers are launched. Giving priority to each individual server is also applicable depending on the desired implementation. In FIG. 2, a larger value indicates a higher priority of placement. This is an example of an expression of priority. Different means of expression may also be applicable. Affinity setting against zones is an example. Affinity setting against other units such as a server or a region may also be used. These multiple types of units may be combined.

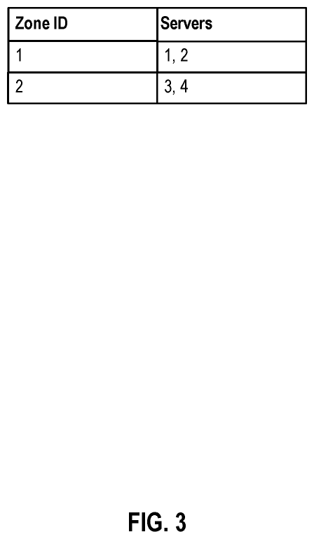

FIG. 3 illustrates an example of the server configuration information, in accordance with some embodiment. The server configuration information manages the list of servers that belong to each zone. For example, servers “1” and “2” belong the zone with the zone ID of “1”.

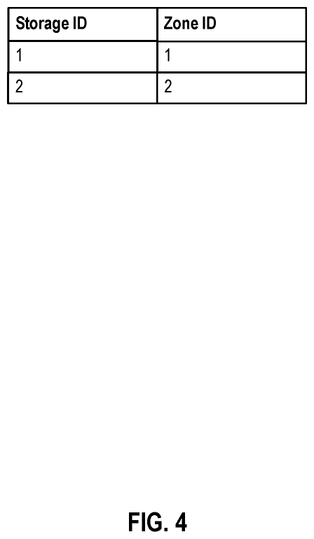

FIG. 4 illustrates an example of the storage configuration information, in accordance with some embodiment. This example shows list of storage systems belonging to each zone. The examples of FIGS. 3 and 4 are one example that is based on the zone configuration to determine network distance among servers and storages. Depending on the desired implementation, the information describing the relationships of the network connections is also applicable to the server and storage information. In such an embodiment, the information further indicates which switches are connected to which servers and storage systems. By analyzing these information, we can understand how many switches is used when servers communicate with each storage. We can treat the number of switches as distance on network. Fewer intervening switches in the communication between a server and a storage indicates that the distance between them is closer.

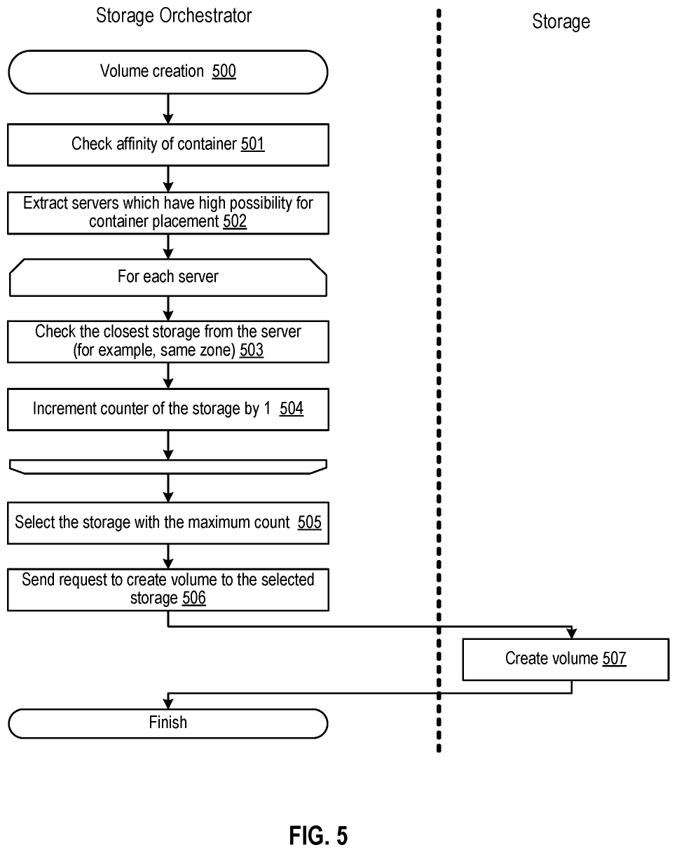

FIG. 5 illustrates an example of the volume creation function in accordance with a first embodiment. The function is initiated when the storage orchestrator is instructed to conduct volume creation at 500. At 501, the storage orchestrator checks the affinity of container that is to be placed. At 502, the storage orchestrator extracts a list of servers to which the container is likely to be placed. For example, based on affinity setting illustrated in FIG. 2 and server configuration illustrated in FIG. 3, servers with server ID “1” and “2” are extracted for container with the container ID “1” because the zone with the zone ID “1” has a higher priority for launching the container and servers with the server ID “1” and “2” belongs the zone.

For 503 and 504, a loop is initiated to parse through each server in the list of extracted servers. At 503, the storage orchestrator checks for the closest storage from each server in the list. Storage orchestrator selects the closest storage to the server. In the example of processing based on zone configuration, the storage orchestrator measures distance based on zones that servers and storage systems belongs to. For example, the storage located in the same zone as the server can be considered to be the closest storage. This processing may be implemented based on the relationships of the network connections. In this case, storage orchestrator measures distance as the number of switches which are used when servers communicate with each storage.

At 504, the counter score for the selected storage is incremented by 1. At 505, the storage having the highest counter score is selected for the volume creation. At 506, the storage orchestrator transmits a request to the selected storage having the highest counter score to create the volume. At 507, the storage creates the volume according to the request.

In a second embodiment, there is a method of determining necessity of volume migration based on estimated running time of container. Hereinafter, a difference with the first embodiment will be mainly described, and the description of the points that are in common with the first embodiment will be simplified or omitted.

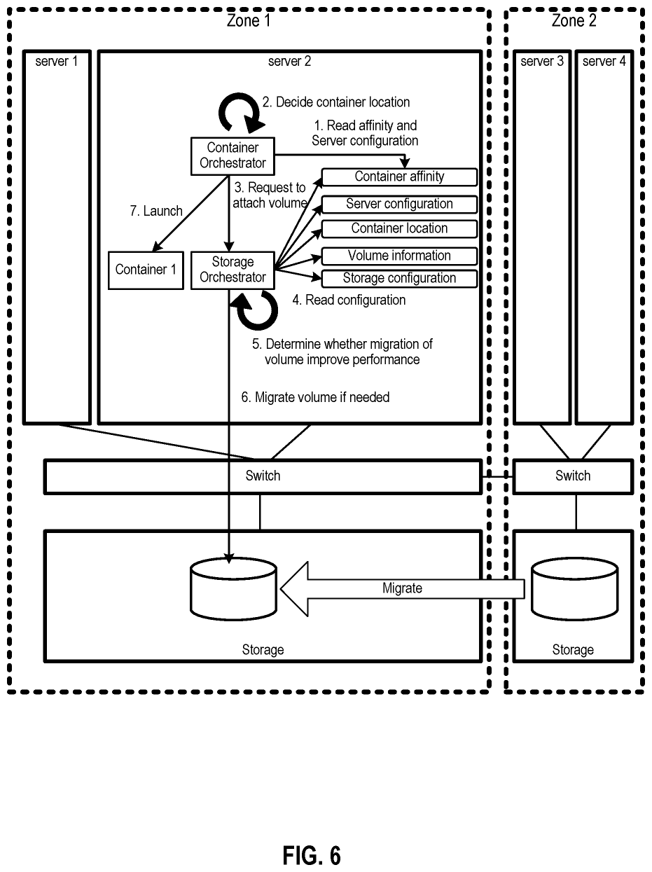

FIG. 6 illustrates an example of a system and an overall processing flow, in accordance with a second embodiment. When the container is subsequently launched, the container can re-mount an existing volume created at the initial execution. Then, the container may launch on a different server from the initial execution. In such a situation, the distance between container and volume may increase and the Input/Output (I/O) latency may get worse. To prevent this, this embodiment migrate the volume to a storage that is closer to the container. Storage orchestrator refers to information such as volume information and container location to determine the necessity of volume migration. Further, if needed, storage orchestrator instructs storages to migrate volume.

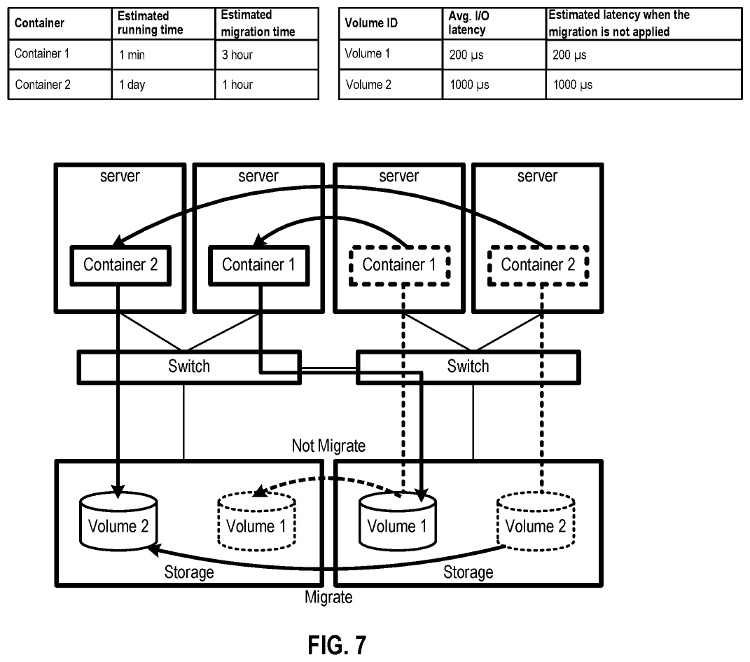

In the second embodiment illustrated at FIG. 6, at first, the container orchestrator reads the affinity and server configuration to determine the container location. Then, the storage orchestrator reads the configuration such as the server configuration, container location, volume information and storage configuration to determine whether the migration of the volume would improve performance or not. If so, then the storage orchestrator migrates the volume as needed before the container is launched, as will be shown in the process of FIG. 7 to FIG. 10. The volume migration may be performed during launching the container. The volume migration may also be performed in the background after the container is launched.

FIG. 7 illustrates an example determination of the necessity of volume migration, in accordance with a second embodiment. Container 1 and container 2 are launched at different servers from the last execution, and the distances between container and volume have increased. In the example of FIG. 7, the volume used by container 1 should not be migrated because the estimated I/O latency when migration is not applied is not worse compared with the average I/O latency measured at last execution, and the estimated running time of container is shorter than estimated migration time. The container may be launched on a closer server to the volume at the next execution. Thus, if the running time is short, the migration process should be avoided to prevent increasing load because I/O performance may be recovered on a subsequent execution. On the other hand, the volume used by container 2 should be migrated because I/O latency will get worse and the estimated running time of the container is much longer than the estimated migration time. The performance of container 2 might not improve soon enough because the running time of container 2 may be long in comparison to the migration time (e.g., 1 day vs. 1 hour to migrate).

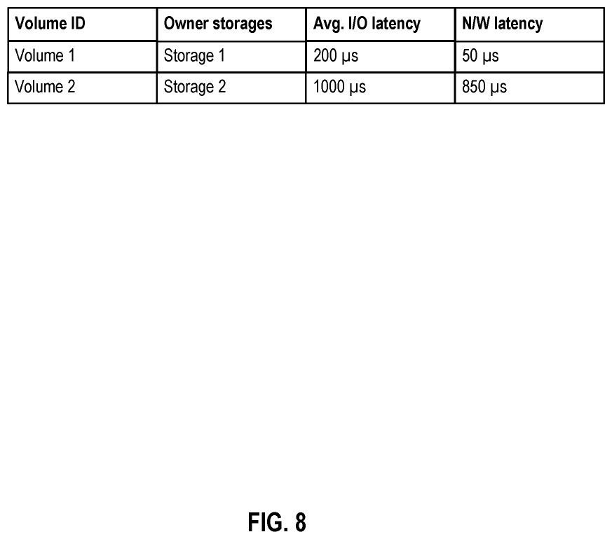

FIG. 8 illustrates an example of volume information, in accordance with a second embodiment. This example has an owner storage (location) indicating which storage system owns the volume, average I/O latency and Network (N/W) latency of each volume. Average I/O latency is a measured value during the previous execution of container. N/W latency is the round-trip time between the server on which container was executed at the last time and the storage which owns the volume. N/W latency can be measured by the storage orchestrator with common tool such as a ping command for an Internet Protocol (IP) network and Fibre Channel Ping (fcping) for a Fibre Channel network. Such information manages the values measured at the last execution of the container. For example, the volume 1 is owned by storage 1, the average I/O latency of volume 1 at last container execution is 200 s and N/W latency of volume 1 is 50 μs. Generally, N/W latency is a part of I/O latency.

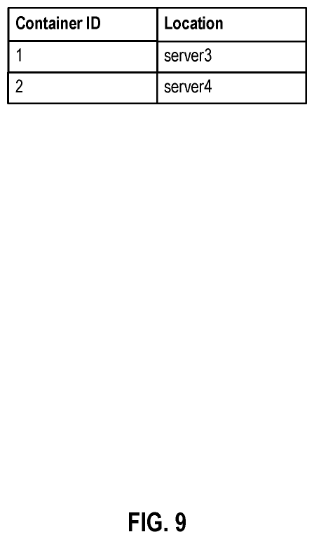

FIG. 9 illustrates an example of container location information, in accordance with a second embodiment. The container location information indicates the container location at the last execution. For example, the container with Container ID 1 was executed on Server 3 at the last iteration.

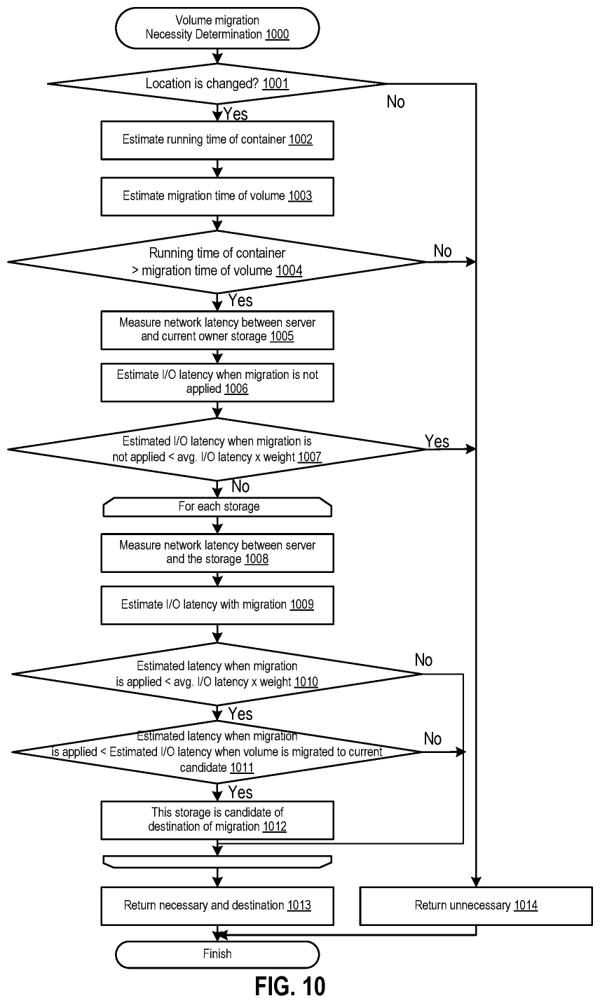

FIG. 10 illustrates an example flow diagram for the determination of the necessity of volume migration, in accordance with a second embodiment. As illustrated in FIG. 10, if one of the following conditions is false, then the process proceeds to 1015 and determines that migration is unnecessary. The process is invoked at 1000 based on the flow as illustrated in FIG. 7 and executed by the storage orchestrator.

At 1001, a determination is made as to whether the container location is changed. This can be determined by comparison between container location at last time recorded in container location information and the location this time. If so (Yes), then an estimate is conducted to determine the running time of the container at 1002 and an estimate of the migration time of the volume 1003 is also conducted. In an example of an estimation of the running time of the container 1002, the average running time for the past executions of the container can be used, or other estimations (e.g., preset server functions that measure running time) can also be utilized in accordance with the desired embodiment. In an example of estimation for the migration time, one example formula can be:

Estimated migration time=(volume size)/(migration band width)

If the container uses multiple volumes, one example formula can be:

Estimated migration time=(total size of each volumes)/(migration band width)

However, other estimations of migration time can be utilized (e.g. preset server functions for indicating expected migration time) in accordance with the desired embodiment.

At 1004, based on the estimations, a determination is made as to whether the estimated running time of the container is longer than the estimated migration time of the volume. If not so (no), then the process proceeds to 1015 and determines that migration is unnecessary. If so (Yes), then the process proceeds to 1005. For this determination, estimated running time of the container may be compared with a threshold for migration time of the volume. The weighted estimated migration time of the volume can be used as the threshold. The weight is a positive and bigger than 1. In this example, the storage orchestrator can determine whether estimated running time of the container is sufficiently long enough than the estimated migration time of the volume. As another example of the threshold, the predetermined value plus estimated migration time can be used.

At 1005, the N/W latency between the server and the current owner storage is measured. At 1006, an estimation of the I/O latency when migration is not applied is conducted. In an example of the estimation of the I/O latency when migration is not applied, one example formula can be:

Estimated I/O latency=(average I/O latency)+{(N/W latency A)−(N/W latency B)}

In the example formula, N/W latency A is the round-trip time between the server that is new location and current volume owner storage. This latency was measured at 1005. N/W latency B is the round-trip time between the server that is last location and current volume owner storage. Such latency is measured at the last execution and recorded in volume information.

At 1007, a determination is made as to whether the estimated I/O latency when migration is not applied is worse than the average I/O latency measured at the last execution. If so (Yes), then it is determined that migration is necessary. For this determination, we compare the estimated I/O latency when migration is not applied with a determined latency threshold (e.g., weighted average I/O latency, latency measured at last execution, etc. in accordance with the desired implementation) determined or measured at the last execution in order to determine whether I/O latency is significantly worse. In this case, the weight is positive number which is equal to or bigger than 1.

To determine a migration destination, the storage orchestrator executes a loop to parse each storage system managed by the system, and then measures the N/W latency between the server that is a new location of the container and each storage system at 1008 and then estimates I/O latency when migration is applied 1009. An example of an estimation method of I/O latency can be as follows:

Estimated I/O latency=(average I/O latency)+{(N/W latency C)−(N/W latency B)}

N/W latency C is the round-trip time between the server that is a new location of the container and the migration destination storage. This latency is measured during the current execution of the container.

To select a storage system for the destination, storage orchestrator conducts the following. First, a determination is made as to whether the estimated I/O latency for the storage is sufficiently short enough than when migration is not applied and whether the estimated I/O latency is the shortest among all storage systems. That is, at 1010, a determination is made as to whether the estimated I/O latency when migration is applied is less than the average I/O latency as normalized with a weight. In this case, the weight is positive number which is equal to or less than 1. This is a example of determination whether estimated I/O latency for the storage is sufficiently short enough. Another method can be applied. For example, a determination is made as to whether the estimated I/O latency when migration is applied is improved more than threshold. If so, (Yes) then the flow proceeds to 1011 to determine whether the estimated I/O latency when migration is applied is less than estimated I/O latency when volume is migrated to a current candidate. At first round of this loop processing, the estimated I/O latency when migration is not applied is used as the Estimated I/O latency when volume is migrated to a current candidate. a skip of 1011 (treat as true) can be also applied at first round of this loop. If both conditions are met, then the storage system is selected as a candidate destination of the migration at 1012.

At 1013, a determination is made as to whether there is a candidate of the migration. If not so (no), the process proceeds to 1015 and determines that migration is unnecessary. If so (yes), at 1014, the process returns an indication that migration is necessary and returns the candidate destination storage system for the container.

Through the embodiments described herein, the performance of data access in the application platform can be improved based on the container.

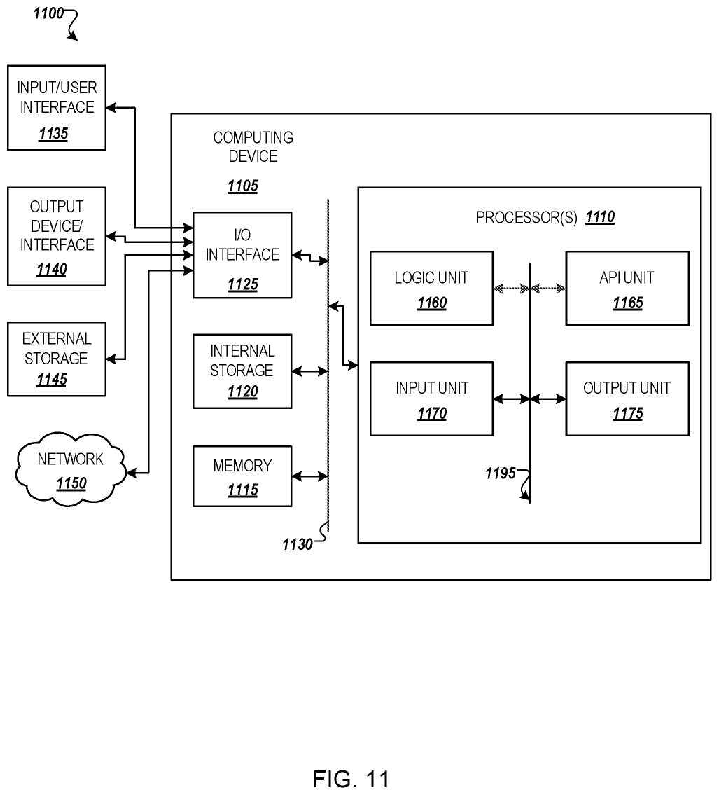

FIG. 11 illustrates an example computing environment with an example computer device suitable for use in some embodiments, such as a server or storage system as illustrated in FIG. 1 or FIG. 6. In another embodiment, the computer device can be in the form of a management server configured to manage the servers and storage systems illustrated in FIG. 1 or FIG. 6. Computer device 1105 in computing environment 1100 can include one or more processing units, cores, or processors 1110, memory 1115 (e.g., RAM, ROM, and/or the like), internal storage 1120 (e.g., magnetic, optical, solid state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired embodiments.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some embodiments, input/user interface 1135 and output device/interface 1140 can be embedded with or physically coupled to the computer device 1105. In other embodiments, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, Fibre Channel, SCSI, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Go, Python, Perl, JavaScript, and others).

Memory 1115 can be configured to store program such as Operating System(OS), Hypervisor, and applications including a container orchestrator, a storage orchestrator, and containers.

Memory 1115 can also be configured to store and manage configuration information such as illustrated in FIGS. 2-4 and 7-9.

Processor(s) 1110 can be in the form of physical hardware processors (e.g., Central Processing Units (CPUs), field-programmable gate array (FPGA), application-specific integrated circuit (ASIC)) or a combination of software and hardware processors.

Processor(s) 1110 can fetch execute programs which are stored in memory 1115. When processor(s) 1110 execute programs, processor(s) 1110 fetch instructions in the programs from memory 1115 and execute them. When processor(s) 1110 execute programs, processor can load information such as illustrated im FIGS. 2-4 and 7-9 from memory. Processor(s) 1110 can pre-fetch and cache instruction of programs and information to improve performance.

One or more applications executed on processor(s) 1110 can include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided.

As illustrated in FIG. 1 and FIG. 6, processor(s) 1110 is configured to facilitate container management in a system having a plurality of servers and a plurality of storage systems through executing the container orchestrator and the storage orchestrator. For a request for volume creation for a container to be launched, processor(s) 1110 are configured to determine, from configuration information as illustrated in FIGS. 2 to 4, one or more servers from the plurality of server to which the container is likely to be launched as illustrated at 501 and 502 of FIG. 5; selecting a storage system from the plurality of storage systems that is closest to the one or more servers to which the container is likely to be launched as illustrated at 503-505 of FIG. 5; creating a volume on the selected storage system as illustrated at 506-507 of FIG. 5; and launching the container as illustrated in FIG. 1.

As illustrated in FIG. 2, configuration information can include container affinity information indicative of a priority for launching the container in a zone of the system. Processor(s) 1110 can be configured to determine, from the configuration information, the one or more servers from the plurality of server to which the container is likely to be launched by determining a highest priority unit(e.g. zone, server) from the container affinity information for the container to be launched based on the container affinity information of FIG. 2; and select the one or more servers associated with the highest priority unit based on the configuration information illustrated in FIG. 3 and as illustrated at 502 of FIG. 5.

Processor(s) 1110 can be configured to select the storage system from the plurality of storage system by, for each of the one or more servers, selecting a closest storage system to the each of the one or more servers as illustrated at 503 and 504 of FIG. 5; and selecting the storage system from the plurality of storage systems that was selected as the closest storage system a highest number of times as illustrated at 505 of FIG. 5. As illustrated at 504 and 505 of FIG. 5, the selecting of the closest storage system to the each of the one or more servers can be determined based on having a same zone as the each of the one or more servers.

Processor(s) 1110 can be configured, to for a detection of a change in location to the launched container as illustrated at 1001 of FIG. 10 and FIG. 6, determine whether migration of the volume improves performance as illustrated at FIG. 6; and for the determination that migration of the volume improves performance, selecting another storage system from the plurality of storage systems for the migration of the volume based on estimated input/output (I/O) latency with the migration and a latency between a server from the plurality of servers managing the launched container and the selected storage system as illustrated at 1010-1014 of FIG. 10; and migrating the volume from the storage system which currently has the volume to the selected another storage system as illustrated at FIG. 6.

Processor(s) 1110 can be configured to determine whether the migration of the volume is necessary by estimating a running time of the launched container as illustrated at 1002 of FIG. 10; estimating a migration time for the volume as illustrated at 1003 of FIG. 10; and for the estimated migration time of the volume exceeding the estimated running time of the launched container, determining that migration does not improve performance as illustrated at 1004 and 1014 of FIG. 10.

Processor(s) 1110 can be configured to determining whether the migration of the volume is necessary by determining whether the I/O latency significantly worsens when the migration is not applied based on the configuration information by determining the latency between the server from the plurality of servers which the container will be launched on and the storage system which currently has the volume as illustrated at 1005 of FIG. 10; estimating an I/O latency when migration is not applied as illustrated at 1006 of FIG. 10; and for the latency when the migration is not applied being longer than a weighted average I/O latency at last execution of the container, determining that migration of the volume is necessary as illustrated at 1007.

Processor(s) 1110 can be configured to select another storage system from the plurality of storage systems for the migration of the volume based on the estimated I/O latency with the migration and the latency between the server from the plurality of servers managing the launched container and the selected storage system by selecting the another storage system from the plurality of storage systems having the estimated I/O latency with the migration being less than a weighted average latency derived from the latency between the server from the plurality of servers managing the launched container and the selected storage system and being less than a current minimum latency as illustrated at 1010 to 1015 of FIG. 10.

Although the example implementations described herein is described with respect to container management, other types of computing unit management can also be facilitated by the example implementations described herein. For example, other computing units can include virtual machines (VMs), application programs, programs, processes, and jobs facilitated by the servers and storage systems in accordance with the desired implementation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the embodiments are not described with reference to any particular programming language. It will be appreciated that a variety of programming languages may be used to implement the teachings of the embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the embodiments may be implemented using circuits and logic devices (hardware), while other aspects may be implemented using instructions stored on a machine-readable medium (software), which if executed by a processor, would cause the processor to perform a method to carry out implementations of the present application. Further, some embodiments of the present application may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described embodiments may be used singly or in any combination. It is intended that the specification and embodiments be considered as examples only, with the true scope and spirit of the present application being indicated by the following claims.

What is claimed is:

1. A method for storage management in conjunction with computing unit management in a system comprising a plurality of servers and a plurality of storage systems, the method comprising:
for a request of creating a new volume or attaching an existing volume for a computing unit to be launched:
determining, from configuration information, one or more servers from the plurality of servers to which the computing unit is to be launched;
estimating performance for each storage system among at least a subset of the plurality of storage systems connected to the determined one or more servers;
selecting a storage system from the at least the subset of the plurality of storage systems connected to the determined one or more servers based on the estimated performance; and
creating a new volume or migrating an existing volume to the selected storage system.

2. The method of claim 1, further comprising:
for the request involving the creating the new volume for the computing unit to be launched:
selecting the storage system from the at least the subset of the plurality of storage systems that is closest to the one or more servers to which the computing unit is to be launched; creating a volume on the selected storage system.

3. The method of claim 2, wherein the configuration information comprises computing unit affinity information indicative of a priority for launching the computing unit in some types of units in the system, and
wherein the determining, from the configuration information, the one or more servers from the plurality of servers to which the computing unit is to be launched comprises:
determining a highest priority unit from the computing unit affinity information for the computing unit to be launched; and
selecting the one or more servers associated with the highest priority unit.

4. The method of claim 2, wherein the selecting the storage system from the at least the subset of the plurality of storage systems comprises:
for each of the determined one or more servers, selecting a closest storage system to the each of the determined one or more servers; and
selecting the storage system from the plurality of storage systems that was selected as the closest storage system a highest number of times.

5. The method of claim 4, wherein the selecting the closest storage system to the each of the one or more servers is determined based on having a same unit as the each of the one or more servers.

6. The method of claim 1, further comprising:
for the request involving attaching the existing volume for the computing unit to be launched:
detecting a change of location of the computing unit to be launched;
determining a necessity for volume migration;
for a determination that the volume migration is necessary:
for the migration of the volume, selecting another storage system from the plurality of storage systems having a shorter latency than a determined latency threshold at a last execution of the computing unit based on estimated input/output (PO) latency when the migration is applied; and
migrating the volume from the storage system currently managing the volume to the selected another storage system.

7. The method of claim 6, wherein the determining the necessity of the volume migration comprises:
estimating a running time of the launching computing unit;
estimating a migration time for the volume;
for the estimated migration time of the volume exceeding the estimated running time of the computing unit, determining that migration is not necessary.

8. The method of claim 6, wherein the determining the necessity of the volume migration comprises:
estimating input/output (I/O) latency when migration is not applied;
for the estimated input/output latency when migration is not applied being equal to or longer than the determined latency threshold at the last execution of the computing unit, determining that migration of the volume is necessary.

9. The method of claim 6, wherein the selecting another storage system from the plurality of storage systems for the migration of the volume based on the estimated I/O latency when the migration is applied comprises:
selecting the another storage system from the plurality of storage systems having the estimated I/O latency when the migration is applied being less than the determined latency threshold at the last execution of the computing unit and having a smallest estimated I/O latency among the plurality of storage systems.

10. A non-transitory computer readable medium, storing instructions for storage management in conjunction with computing unit management in a system comprising a plurality of servers and a plurality of storage systems, the instructions comprising:
for a request of creating a new volume or attaching an existing volume for a computing unit to be launched:
determining, from configuration information, one or more servers from the plurality of servers to which the computing unit is to be launched;
estimating performance for each storage system among at least a subset of the plurality of storage systems connected to the determined one or more servers;
selecting a storage system from the at least the subset of the plurality of storage systems connected to the determined one or more servers based on the estimated performance; and
creating a new volume or migrating an existing volume to the selected storage system.

11. The non-transitory computer readable medium of claim 10, the instructions further comprising:
for the request involving the creating the new volume for the computing unit to be launched:
selecting the storage system from the at least the subset of the plurality of storage systems that is closest to the one or more servers to which the computing unit is to be launched;
creating a volume on the selected storage system.

12. The non-transitory computer readable medium of claim 11, wherein the configuration information comprises computing unit affinity information indicative of a priority for launching the computing unit in some types of units in the system, and
wherein the determining, from the configuration information, the one or more servers from the plurality of servers to which the computing unit is to be launched comprises:
determining a highest priority unit from the computing unit affinity information for the computing unit to be launched; and
selecting the one or more servers associated with the highest priority unit.

13. The non-transitory computer readable medium of claim 11, wherein the selecting the storage system from the at least the subset of the plurality of storage systems comprises:
for each of the determined one or more servers, selecting a closest storage system to the each of the determined one or more servers; and
selecting the storage system from the plurality of storage systems that was selected as the closest storage system a highest number of times.

14. The non-transitory computer readable medium of claim 13, wherein the selecting the closest storage system to the each of the one or more servers is determined based on having a same unit as the each of the one or more servers.

15. The non-transitory computer readable medium of claim 10, the instructions further comprising:
for the request involving attaching the existing volume for the computing unit to be launched:
detecting a change of location of the computing unit to be launched;
determining a necessity for volume migration;
for a determination that the volume migration is necessary:
for the migration of the volume, selecting another storage system from the plurality of storage systems having a shorter latency than a determined latency threshold at a last execution of the computing unit based on estimated input/output (I/O) latency when the migration applied; and
migrating the volume from the storage system currently managing the volume to the selected another storage system.

16. The non-transitory computer readable medium of claim 15, wherein the determining the necessity of the volume migration comprises:
estimating a running time of the launching computing unit;
estimating a migration time for the volume;
for the estimated migration time of the volume exceeding the estimated running time of the computing unit, determining that migration is not necessary.

17. The non-transitory computer readable medium of claim 15, wherein the determining the necessity of the volume migration comprises:
estimating input/output (I/O) latency when migration is not applied;
for the estimated input/output latency when migration is not applied being equal to or longer than the determined latency threshold at the last execution of the computing unit, determining that migration of the volume is necessary.

18. The non-transitory computer readable medium of claim 15, wherein the selecting another storage system from the plurality of storage systems for the migration of the volume based on the estimated I/O latency when the migration is applied comprises:
selecting the another storage system from the plurality of storage systems having the estimated I/O latency when the migration is applied being less than the determined latency threshold at the last execution of the computing unit and having a smallest estimated I/O latency among the plurality of storage systems.
